(19) United States
(12) Patent Application Publication
(10) Pub. No.: US 2010/0040762 A1
(43) Pub. Date: Feb. 18, 2010

(54) GREEN TEA EXTRACT, ESPECIALLY FOR USE AS A FUNCTIONAL FOOD ITEM, FOOD SUPPLEMENT, OR CORRESPONDING INGREDIENT, USE THEREOF, AND PROCESS FOR PRODUCING SUCH A GREEN TEA EXTRACT

(75) Inventors: Adolf Kler, Neustadt/Aisch (DE); Reinhold Zenger, Adelsdorf (DE); Wilfried Dimpel, Wetzlar (DE)

Correspondence Address: BROWDY AND NEIMARK, P.L.L.C.;624 NINTH STREET, NW, SUITE 300, WASHINGTON, DC, 20001-5303, US

(73) Assignee: Plantextrakt GmbH & Co. KG, Vestenbergsgreuth (DE)

(21) Appl. No.: 12/442,991

(22) PCT Filed: Sep. 25, 2007
(86) PCT No.: PCT/EP2007/008309

§ 371 Date: Mar. 26, 2009

(30) Foreign Application Priority Data
Sep. 26, 2006 (DE) 10 2006 045 763.3

(51) Int. Cl. A23F 3/16; A23F 3/20; A23F 3/22

(52) U.S. Cl. 426/655; 426/424

(57) ABSTRACT

A green tea extract, especially for use as a functional food item, food supplement, or corresponding ingredient has an enriched content of theanine and theogallin and is decaffeinated.

The invention relates to a green tea extract, especially for use as a functional food item, food supplement, or corresponding ingredient thereto, as well as to the use thereof and to a process for producing such a green tea extract.

Regarding the background of the invention, it can be stated that changes in eating habits, a new degree of health consciousness, coupled with the desire to have available not only tasty, safe foods, but also foods with certain positive nutritional properties are emerging.

Aside from nutrients that have been commonly known and described until now, such as e.g. protein, fat, carbohydrates, dietary fiber, vitamins, mineral nutrients, etc., so-called secondary plant substances (SPS) have also recently started to play an increasingly more important role. These secondary plant substances comprise a large number of various kinds of chemical compounds or compound classes, such as e.g. carotinoids, terpenes, phytosterols, polyphenols, etc., as they were described also by the German Nutrition Society (Deutsche Gesellschaft für Ernährung, DGE) in the German Nutrition Report 1996.

Many plants, particularly also herbs and teas, are rich in secondary plant substances, and for that reason represent a suitable starting material for producing plant extracts with SPS. These extracts may be used as a food item or food ingredient for producing a multitude of food items, such as e.g. beverages, dairy products, baked goods, sweets, etc., and give certain functional properties to the ready-to-eat food product.

Especially tea and green tea, both products of the tea-plant (Camellia sinensis/Camellia assamica and their hybrids) are rich in SPS such as e.g. in known substances like caffeine or polyphenols, whose physiological effects are commonly known. Black tea and green tea, as well as their extracts furthermore contain other nutritionally very interesting compounds, such as e.g. amino acids, theanine, theogallin.

Theanine is a derivative of glutamic acid, called 5-N-ethyl-L-glutamine. For theanine, certain nutritional effects are already described. Essentially, these are relaxing, stress-inhibiting, calming properties. However, indications of stimulating properties exist as well.

Theogallin is an ester of gallic acid with quinic acid, called 5-galloyl quinic acid. Nothing is known about theogallin and its nutritional effects in the tea beverage or in tea extracts.

Regarding the prior art, it can be stated that the commonly known stimulating properties of caffeine have been described for a long time. With regular consumption of coffee, particularly in large amounts, however, there also exist the drawbacks that have been described for coffee, such as sleeplessness, restlessness, reduced cerebral blood flow, etc. (see Hager-ROM 2004 Hagers Handbuch der Drogen und Arzneistoffe).

For theanine in the form of the pure substance, calming properties are described on one hand (see JP 2005 289 948 A1, JP 2005 232 045 A1, or JP 9012454 A1) and also stimulating properties on the other hand (see JP 9100230 A1). This is particularly true of theanine in mixture with caffeine, arginine, rice bran extract (see JP 2002 3220 53 A1, KR 10 2005 121 535 A1 or U.S. Pat. No. 2005 0020 627 A1).

From DE 101 06 216 A1, a green tea extract is known that is decaffeinated, low in tannins, but enriched in terms of L-theanine. It is produced by first decaffeinating green tea leaves, green tea fannings or green tea powder and subsequently extracting them in water. The extract is then brought into contact with polystyrene and subsequently concentrated. The extract is used as an ingredient to beverages or beverage concentrates.

From EP 10 57 483 A1, a pharmaceutically active composition for treating various symptoms such as obesity, premenstrual symptoms or sensitivity to cold is known that contains theanine.

From EP 10 74 252 B1, a theanine-containing composition for suppressing behavioral problems in pets is known.

In addition, a whole variety of plants and plant extracts that have positive effects on the human metabolism are already described in the patent literature, such as, e.g. in Korean patent application KR 1020030056987A, a composition with green tea catechin as an active substance for the prophylaxis of heart and vascular diseases that are associated with diabetes.

This is of importance because, by common consent, the living conditions, particularly in highly civilized countries with unbalanced nutrition and lack of exercise, must be seen as the main cause for excess weight, diabetes and further metabolic diseases. This is reflected in an increase in type 2 diabetes cases in the population.

To counter this trend, the goal must be a balanced nutrition and adequate exercise. Within this setting functional foods can in the sense of a prophylaxis contribute to or at least help with maintaining the blood sugar level within a physiological range in persons at risk.

The present invention is now based on the object of developing a special green tea extract that, as a functional food with broad applications, effects for instance an increase in cognitive performance with concomitant relaxation and that may be used as a functional food item or corresponding food ingredient in beverages, dairy products, sweets, etc.. The goal is to develop functional foods that are intended to guarantee, particularly to brainworkers, an improved and extended cognitive performance with concomitant relaxation. Another interesting object is the potential positive impact on the human glucose household by such a green tea extract.

This object is met in terms of production technology by a green tea extract of the composition specified in claim 1.

Studies with a decaffeinated, theanine and theogallin-enriched green tea extract surprisingly have shown that when such an extract is used, for example in a soft drink, an increase in cognitive performance with concomitant relaxation can be detected.

Surprisingly, studies such as e.g. a screening of a multitude of plant extracts on the subject “blood sugar regulation, anti-diabetic properties of plant extracts” have additionally revealed that the inventive green tea extract also has blood-sugar regulating properties. It has emerged that this theanine and theogallin-enriched green tea extract, decaffeinated, is able to markedly increase the glucose uptake of differentiated adipocytes.

The preferred degrees of enrichment for theanine and theogallin were found to be at least six percent and at least three percent, respectively, with a caffeine content of maximally 0.03 percent.

In terms of production technology, the invention specifies a process for producing a green tea extract that has the following process steps:
a) aqueous extraction of green tea leaves,
b) liquid-liquid extraction of the aqueous green tea extract obtained in step a),
c) adsorptive enrichment in an adsorber of the extract obtained in step b),
d) elution of the adsorber,
e) concentration of the eluate into a decaffeinated, theanine and theogallin-enriched green tea extract with a dry matter content of preferably at least 50%.

On the basis of these basic process steps, which are specified in detail in the additional, dependent claims, the above-mentioned percentages of theanine, theogallin and caffeine can be attained.

Additional characteristics, details and advantages of the invention will become apparent from the following description, which refers to an

### Exemplary Embodiment

For the production of the inventive extract, green tea is used as a raw material. It is subjected in a first step to an aqueous extraction—step a) of the production process.

The aqueous green tea extract that is obtained in this manner is subjected in a second step to a liquid-liquid extraction—step b)—by means of ethyl acetate. In the process, caffeine and a portion of the polyphenols are removed, leading to an enrichment with the desired substances theanine and theogallin.

An additional adsorptive enrichment takes place in a third process stage—step c)—via an adsorber that is filled with functionalized divinylbenzene. The aqueous permeate that accumulates in the process is to be discarded. The elution—step d)—is carried out with demineralized water, and two separate partial fractions are obtained in the process. Particularly the second partial fraction is rich in theanine, theogallin and amino acids that are contained in green tea.

In a further stage—step e)—the respective fraction is concentrated to a dry matter content of approximately 50% and may already be used as such. The concentrated, theanine and theogallin-enriched green tea extract that is obtained in this manner may be spray-dried in a further process step.

The green tea extract that is produced as described above substantially has the following composition relative to dry substance:

| | |
|---|---|
| water content | 3.2% |
| ash content | 24.1 |
| sum of amino acids | 3.52% |
| caffeine | ≦0.01% |
| L-theanine | 9.71% |
| theogallin | 4.65% |

The remainder consists of a multitude of substances. Analyses revealed residual components consisting of 2.5% tannings and 52.3% carbohydrates, acids and acid derivatives.

Various animal studies and one human study have surprisingly shown that a decaffeinated, theanine and theogallin-enriched green tea extract that is produced according to the above-described process has the above-mentioned properties, with particularly theogallin and its metabolites, such as e.g. quinic acid, being responsible for the increase in cognitive performance. Theanine exhibits slightly relaxing properties in the described extract.

Moreover, the ability of the decaffeinated, theanine and theogallin-enriched green tea extract to increase the sugar absorption of a specific cell type, namely adipocytes that were differentiated from murine fibroblasts, was demonstrated in a study that will be described further below. This substantiates the suitability of the green tea extract as a functional food item for supporting a person's glucose household.

The following experimental studies were performed:

Testing of the extract by means of a beverage in a human study

A double-blind, randomized, placebo-controlled crossover human physiological study was performed with twelve test subjects. The verum beverage contained 2.57 g/500 ml inventive green tea extract, the placebo beverage was free of this extract.

As measuring or main outcome parameters, the spectral EEG performance and the visual evoked P300 potential were evaluated. The methods that were used were the quantitative-topographic EEG using the so-called Cateem® system, as well as, for determining the P300, the “Caterpa” analysis method.

The criteria “increase in concentration,” “increase in relaxation,” “increase in mental performance” and “improved cognitive function” show significant improvements based on the above evaluations with the use of the verum beverage as compared to the placebo.

All in all, an improvement of the cognitive function with concomitant relaxation following the consumption of the verum beverage was thus demonstrated.

Test of the total extract and single constituents on the isolated rat brain hippocampal section preparation:

The preparations that were used were section preparations analogous to Dimpfel et. al, 1991 that were subjected to electrical stimulation while recording the extra-cellular field potentials. The measured field potentials were recorded after a single stimulus excitation and theta-burst stimulation.

The following substances were analyzed:
decaffeinated, theanine and theogallin-enriched green tea extract
theogallin 97%
amino acid mixture analogous to green tea extract
amino acid mixture analogous to green tea extract with theanine
L-theanine >90%
quinic acid 98%
gallic acid 98%

The method of the in-vitro hippocampal section analysis was chosen to examine the influence of the green tea extract that was tested in the human study and single constituents thereof on hippocampal nerve-cell tissue. The results show that the subject matter theanine and theogallin-enriched green tea extract is capable of altering the physiological pattern of the hippocampal electrical activity.

It was also shown that a number of substances of the green tea extract influence the electrical activity. Glutamic acid and theogallin and it metabolites, such as e.g. quinic acid, must be regarded as stimulating substances. Theanine exhibits an opposite effect. The effect of theogallin and its metabolites, such as e.g. quinic acid, as substances that improve cognitive performance has not been described until now. The results show a concentration-dependent stimulation on the hippocampal section preparation, which leads to an increase in long-term potentiation, a surrogate parameter for an activation of the spatial and temporal working memory.

The results accordingly supplement and support the results that were obtained in the human study, where an increase in cognitive performance with concomitant relaxation was found as well.

Supplementing in-vivo experiments on unrestrained rats by means of quantitative detection of the electric brain activity (tele-stereo-EEG).

Observed were adult, unrestrained Fischer-344 rats with implanted 4 bipolar concentric brain electrodes. A continuous in-vivo analysis of the electric field potential (tele-stereo-EEG) of the frontal cortex, hippocampus, striatum, and reticular formation was performed analogous to

Dimpfel et. al 1986. Additionally, the mobility of the rats was measured using a video tracking system by GJB Datentechnik GmbH, Langewiesen, Germany.

The following substances were employed:
theanine and theogallin-enriched green tea extract
glutamic acid
L-theanine >90%
theogallin 97%
quinic acid 98%

The “tele-stereo-EEG” model on unrestrained rats was chosen as the in-vivo model to validate results that were obtained following the rat-hippocampus in-vitro experiments, in particular the crossing of the blood-brain barrier for the described substances.

The oral administration of the total extract shows a time-dependent pronounced stimulation of the field potentials, characterized by a decrease in the delta, theta and alpha frequencies. Of the tested single substances that are present in the extract, theanine, theogallin and quinic acid are the substances that principally contribute to the measured results. The in-vivo results that were obtained in the rat telestereo-EEG consequently point to the ability of the described green tea extract, or of the constituents contained in the extract, to also cross the blood-brain barrier in humans.

The results accordingly support the data that was obtained in the human study, where it was shown that the subject matter green tea extract leads to an increase in cognitive performance with concomitant relaxation.

Glucose uptake test as in-vitro study:

For a blood sugar absorption test, 3T3-L1 cells (murine fibroblasts) were differentiated in three differentiation steps over 8-9 days with insulin (1 μg/ml), dexamethasone (40 μM) and IBMX (500 μM) into adipocytes. In the second differentiation step, the cells (60000 cells/well) were seeded in cell culture dishes. For the assay, the cells were incubated in serum-free medium for 3 hours. After pre-incubation of the cells with a 0.16 μM insulin solution and the green tea extracts for 25 min at 37° C., the assay was started with 2-desoxy-D-[1-³H]-glucose (0.11 μCi/ml) and incubated for 25 min at room temperature. The amount of 2-desoxy-D-[1-³H]-glucose taken up by the cells was measured by means of a scintillation counter after various washing steps and lysis of the cells. The measurements were performed in a Tri-Carb 1900 TR Liquid Scintillation Counter (Packard, USA). Zero checks (t(0)) were performed without the addition of insulin. As negative control, cytochalasin B (200 μM), an inhibitor of the insulin-stimulated glucose transporter system, was used. The result of the analyses shows that the examined green tea extract more than doubles the glucose uptake within the described incubation time, as compared to the control. This holds true for all three utilized test concentrations of 3 μg/ml, 100 ng/ml, as well as 300 pg/ml.

1-11. (canceled)

12. A green tea extract for use as one of the group of a functional food item, food supplement, and corresponding ingredient, having an enriched content of theanine, wherein the extract additionally contains an enriched content of theogallin and is decaffeinated.

13. A green tea extract as set forth in claim 12, comprising the following constituent percentages relative to the dry matter:

| | |
|---|---|
| theanine | at least 6.0% |
| theogallin | at least 3.0% |
| caffeine | maximally 0.03% |

14. A green tea extract as set forth in claim 12, comprising the following contents relative to the dry matter:

| | |
|---|---|
| water content | 2.0% to 5.0% |
| ash | 20.0% to 30.0% |
| amino acids | 2.0% to 10.0% |
| caffeine | below 0.03% |
| theanine | 6.0% to 40.0%, and |
| theogallin | 3.0% to 20.0% |

15. A green tea extract as set forth in claim 14, comprising the following composition relative to the dry matter:

| | |
|---|---|
| water content | 2.5% to 4.0% |
| ash | 23.0% to 25.0% |
| amino acids | 3.0% to 4.0% |
| caffeine | below 0.01% |
| theanine | 9.0% to 10.5% and |
| theogallin | 4.0% to 5.5%. |

16. A green tea extract as set forth in claim 14, comprising the following composition relative to the dry matter:

| | |
|---|---|
| water content | 3.2% |
| ash | 24.1% |
| amino acids | 3.52% |
| caffeine | below 0.01% |
| theanine | 9.71%, and |
| theogallin | 4.65%. |

17. A process for producing a green tea extract of claim 12, comprising process steps:
a) aqueous extraction of green tea leaves,
b) liquid-liquid extraction of the aqueous green tea extract obtained in step a),
c) adsorptive enrichment in an adsorber of the extract obtained in step b),
d) elution of the adsorber,
e) concentration of the eluate into a decaffeinated, theanine and theogallin-enriched green tea extract having a dry matter content of at least 50%.

18. A process as set forth in claim 17, wherein the liquid-liquid extraction according to step b) is performed by means of ethyl acetate.

19. A process as set forth in claim 17, wherein the adsorptive enrichment in step c) takes place via an adsorber filled with functionalized divinylbenzene.

20. A process as set forth in claim 17, wherein the elution of the adsorber according to step d) is carried out with demineralized water.

21. A process as set forth in claim 17, wherein, in the elution of the adsorber according to step d), two separate partial fractions are obtained, particularly the second, theanine-rich, theogallin-rich and green tea-specific amino-acid-rich partial fraction of which is subjected to the further process steps.

22. A process as set forth in claim 17, wherein the green tea extract obtained in step e) is spray-dried.
